(19) United States
(12) Patent Application Publication
(10) Pub. No.: US 2023/0196854 A1
(43) Pub. Date: Jun. 22, 2023

(54) TIRE REPLACEMENT SYSTEM

(71) Applicant: The Goodyear Tire & Rubber Company, Akron, OH (US)

(72) Inventors: Juliana Maria Lopez De La Cruz, Mamer (LU); Dario Torregrossa, Luxemboug Ville (LU); Michaël Lambé, Harnoncourt (BE)

(21) Appl. No.: 18/055,973

(22) Filed: Nov. 16, 2022

Related U.S. Application Data
(60) Provisional application No. 63/291,494, filed on Dec. 20, 2021.

(51) Int. Cl. G07C 5/08; B60C 11/24; G07C 5/00

(52) U.S. Cl. CPC G07C 5/0825; B60C 11/24; G07C 5/008

(57) ABSTRACT

A replacement system for a tire supporting a vehicle includes a processor in electronic communication with an electronic system of the vehicle, and an electronic memory capacity for storing tire identification information. The processor receives the tire identification information and vehicle data. A prediction model is in electronic communication with the processor and receives the tire identification information and the vehicle data. An identification of a replacement tread depth for the tire is included in the prediction model, and the model determines an estimation of remaining available distance for the tire to reach the replacement tread depth. The model estimates remaining available time to reach the replacement tread depth from the estimation of remaining available distance. A residual correction module optimizes the estimation of the remaining available time for the tire to reach the replacement tread depth, and a notification of a replacement lead time is generated by the system.

### FIELD OF THE INVENTION

The invention relates generally to tire monitoring systems. More particularly, the invention relates to systems that collect tire parameter data to monitor tire wear. The invention is directed to a system for estimating the wear rate of a tire and generating a forecast for replacement of the tire.

### BACKGROUND OF THE INVENTION

Tire wear refers to the loss of material from the tread of the tire as indicated by the depth of the tire tread. Measuring or predicting the wear state of the tire may be beneficial. For example, information about the wear state of a tire may be useful in predicting tire performance during vehicle braking and/or handling, and may be used to determine when a tire should be replaced. In addition, the wear rate of the tire, which is the wear of the tire over time, may be useful in estimating tread depth as a function of time for predictions of tire performance and/or tire life.

Techniques have been developed to directly measure tire wear state using sensors that are attached to the tire. Direct techniques include certain advantages, such as relative simplicity in the approach of measurement of pressure, temperature and/or tread depth with a sensor. Direct techniques also include challenges, such as proper sensor mounting without affecting tire integrity, sensor life and/or transmission of sensor data in the harsh environment of a tire.

Due to such challenges, indirect techniques have been developed. Indirect techniques take certain tire and/or vehicle sensor measurements into account and then generate a prediction or estimate of tire state and/or tire wear rate. While indirect techniques do not necessarily encounter the challenges of sensor mounting, sensor life, and/or transmission of sensor data, they include challenges in achieving accuracy and repeatability in the estimation or prediction that is generated. For example, many indirect techniques have experienced disadvantages in the prior art due to a lack of optimum prediction techniques, which in turn reduces the accuracy and/or reliability of the tread wear predictions.

As a result, there is a need in the art for a system that accurately and reliably estimates the wear rate of a tire and generates a forecast for replacement of the tire.

### SUMMARY OF THE INVENTION

According to an aspect of an exemplary embodiment of the invention, a tire replacement system for a tire supporting a vehicle is provided. The system includes a processor in electronic communication with an electronic system of the vehicle, and an electronic memory capacity for storing identification information for the tire. The processor receives identification information for the tire from the electronic memory capacity and vehicle data from the electronic system of the vehicle. A prediction model is in electronic communication with the processor and receives the identification information for the tire and the vehicle data. An identification of a replacement tread depth for the tire is included in the prediction model, and an estimation of remaining available distance for the tire to reach the replacement tread depth is determined by the prediction model. An estimation of remaining available time to reach the replacement tread depth is determined by the prediction model from the estimation of remaining available distance for the tire to reach the replacement tread depth. A residual correction module is in electronic communication with the processor and optimizes the estimation of the remaining available time for the tire to reach the replacement tread depth. A replacement lead time determination is generated by the tire replacement system and corresponds to the estimation of remaining available time for the tire to reach the replacement tread depth. A notification of the replacement lead time is generated by the tire replacement system and is transmitted to at least one of the electronic system of the vehicle, a cloud-based server, and a display device.

### BRIEF DESCRIPTION OF THE DRAWINGS

The invention will be described by way of example and with reference to the accompanying drawings, in which:

FIG. 1 is a schematic perspective view of one type of vehicle with a sensor-equipped tire employing an exemplary embodiment of the tire replacement system of the present invention;

FIG. 2 is a schematic plan view of the type of vehicle shown in FIG. 1;

FIG. 3 is a schematic perspective view of the type of vehicle shown in FIG. 1 with a representation of data transmission to a cloud-based server and to a user device;

FIG. 4 is a schematic representation of aspects of the exemplary embodiment of the tire replacement system of the present invention;

FIG. 5 is a graphical representation of an aspect of the exemplary embodiment of the tire replacement system of the present invention;

FIG. 6 is a representation of an expression employed in an aspect of the exemplary embodiment of the tire replacement system of the present invention;

FIG. 7 is a representation of another expression employed in an aspect of the exemplary embodiment of the tire replacement system of the present invention;

FIG. 8 is a representation of another expression employed in an aspect of the exemplary embodiment of the tire replacement system of the present invention;

FIG. 9 is a representation of another expression employed in an aspect of the exemplary embodiment of the tire replacement system of the present invention;

FIG. 10 is a graphical representation of another aspect of the exemplary embodiment of the tire replacement system of the present invention;

FIG. 11 is a graphical representation of another aspect of the exemplary embodiment of the tire replacement system of the present invention;

FIG. 12 is a representation of another expression employed in an aspect of the exemplary embodiment of the tire replacement system of the present invention;

FIG. 13 is a representation of another expression employed in an aspect of the exemplary embodiment of the tire replacement system of the present invention;

FIG. 14 is a representation of another expression employed in an aspect of the exemplary embodiment of the tire replacement system of the present invention;

FIG. 15 is a representation of another expression employed in an aspect of the exemplary embodiment of the tire replacement system of the present invention;

FIG. 16 is a representation of another expression employed in an aspect of the exemplary embodiment of the tire replacement system of the present invention;

FIG. 17 is a graphical representation of another aspect of the exemplary embodiment of the tire replacement system of the present invention;

FIG. 18 is a schematic representation of another aspect of the exemplary embodiment of the tire replacement system of the present invention; and

FIG. 19 is a graphical representation of another aspect of the exemplary embodiment of the tire replacement system of the present invention.

Similar numerals refer to similar parts throughout the drawings.

### Definitions

“ANN” or “Artificial Neural Network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Axial” and “axially” means lines or directions that are parallel to the axis of rotation of the tire.

“CAN bus” is an abbreviation for controller area network.

“Circumferential” means lines or directions extending along the perimeter of the surface of the annular tread perpendicular to the axial direction.

“Cloud computing” or “cloud” means computer processing involving computing power and/or data storage that is distributed across multiple data centers, which is typically facilitated by access and communication using the Internet.

“EBS” is an abbreviation for a vehicle electronic braking system.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Groove” means an elongated void area in a tread that may extend circumferentially or laterally about the tread in a straight curved, or zigzag manner.

“Inboard side” means the side of the tire nearest the vehicle when the tire is mounted on a wheel and the wheel is mounted on the vehicle.

“Kalman Filter” is a set of mathematical equations that implement a predictor-corrector type estimator that is optimal in the sense that it minimizes the estimated error covariance when some presumed conditions are met.

“Lateral” means an axial direction.

“Luenberger Observer” is a state observer or estimation model. A “state observer” is a system that provide an estimate of the internal state of a given real system, from measurements of the input and output of the real system. It is typically computer-implemented, and provides the basis of many practical applications.

“MSE” is an abbreviation for mean square error, the error between and a measured signal and an estimated signal which the Kalman filter minimizes.

“Outboard side” means the side of the tire farthest away from the vehicle when the tire is mounted on a wheel and the wheel is mounted on the vehicle.

“PSD” is power spectral density (a technical name synonymous with FFT (fast fourier transform).

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread” means a molded rubber component which includes that portion of the tire that comes into contact with the road when the tire is normally inflated and under normal load.

“Tread depth” means a radial distance or dimension between the radially outermost surface of the tread elements and the radially outermost surface of the deepest groove of the tire.

“Tread element” or “traction element” means a rib or a block element defined by a shape having adjacent grooves.

### DETAILED DESCRIPTION OF THE INVENTION

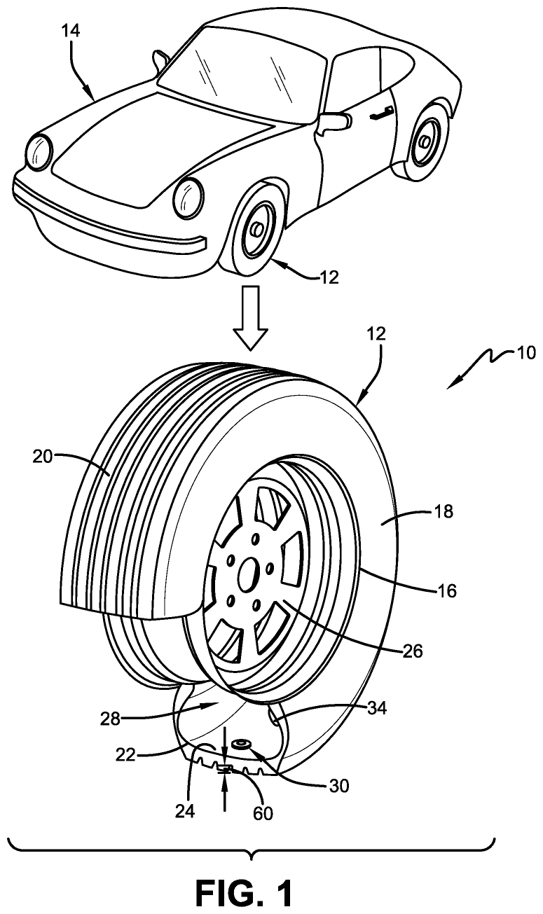

Turning now to FIGS. 1 through 19, an exemplary embodiment of the tire replacement system of the present invention is indicated at 10. With particular reference to FIG. 1, the system 10 estimates the wear rate and forecasts replacement of each tire 12 supporting a vehicle 14. While the vehicle 14 is depicted as a passenger car by way of example for the purpose of convenience, the invention is not to be so restricted. The principles of the invention find application in other vehicle categories such as commercial trucks and trailers, off-the-road vehicles, and the like, in which vehicles may be supported by more or fewer tires.

Each tire 12 includes a pair of bead areas 16 and a pair of sidewalls 18, in which each sidewall extends radially outward from a respective bead area to a ground-contacting tread 20. The tire 12 is reinforced by a carcass 22 that toroidally extends from one bead area 16 to the other bead area, as known to those skilled in the art. An innerliner 24 is formed on the inside surface of the carcass 22. The tire 12 is mounted on a wheel 26 in a manner known to those skilled in the art and, when mounted, forms an internal cavity 28 that is filled with a pressurized fluid, such as air.

A sensor unit 30 may be attached to the innerliner 24 of each tire 12 by means such as an adhesive and measures certain parameters or conditions of the tire 12, as will be described in greater detail below. It is to be understood that the sensor unit 30 may be attached in such a manner, or to other components of the tire 12, such as between layers of the carcass 22, on or in one of the sidewalls 18, on or in the tread 20, and/or a combination thereof. For the purpose of convenience, reference herein shall be made to mounting of the sensor unit 30 on the tire 12, with the understanding that such mounting includes all such attachment.

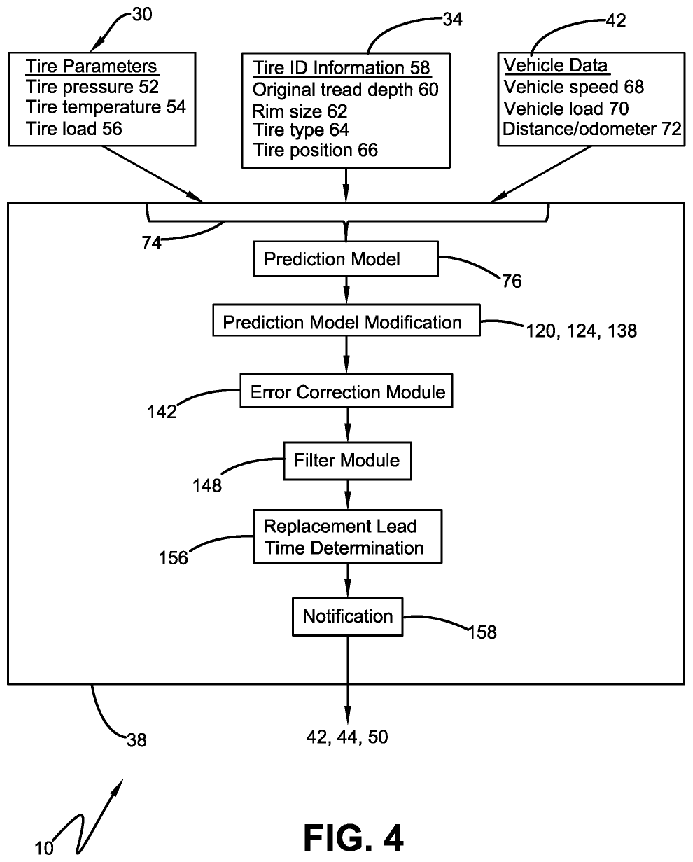

The sensor unit 30 is mounted on each tire 12 for the purpose of detecting certain real-time tire parameters, such as tire pressure 52 (FIG. 4), temperature 54, and/or load 56. Preferably the sensor unit 30 is a tire pressure monitoring system (TPMS) module or sensor, of a type that is commercially available, and may be of any known configuration. For the purpose of convenience, the sensor unit 30 shall be referred to as a TPMS sensor. Each TPMS sensor 30 preferably also includes electronic memory capacity for storing identification (ID) information for each tire 12, known as tire ID information 58. Alternatively, tire ID information 58 may be included in another sensor unit, or in a separate tire ID storage medium, such as a tire ID tag 34.

The tire ID information 58 may include manufacturing information for the tire 12, such as: the tire type 64, such as a passenger tire, truck tire, trailer tire, steer tire, non-steer tire, and the like; tire model; original tread depth 60; size information, such as rim size 62, width, and outer diameter; manufacturing location; manufacturing date; a treadcap code that includes or correlates to a compound identification; and a mold code that includes or correlates to a tread structure identification. The tire ID information 58 may also include a service history or other information to identify specific features and parameters of each tire 12, as well as the location or position 66 of the tire on the vehicle 14. In addition, global positioning system (GPS) capability may be included in the TPMS sensor 30 and/or the tire ID tag 34 to provide location tracking of the tire 12 during transport and/or location tracking of the vehicle 14 on which the tire is installed.

It is to be understood that the TMPS sensor 30 and the tire ID tag 34 may be separate units or may be incorporated into a single sensor unit. In addition, other sensors known to those skilled in the art may be employed in the tire 12 as integrated or separate units. For the purpose of convenience, reference shall be made to the TMPS sensor 30 and the tire ID tag 34 as separate units, with the understanding that they may be incorporated into one integrated unit, and that other sensors may be employed.

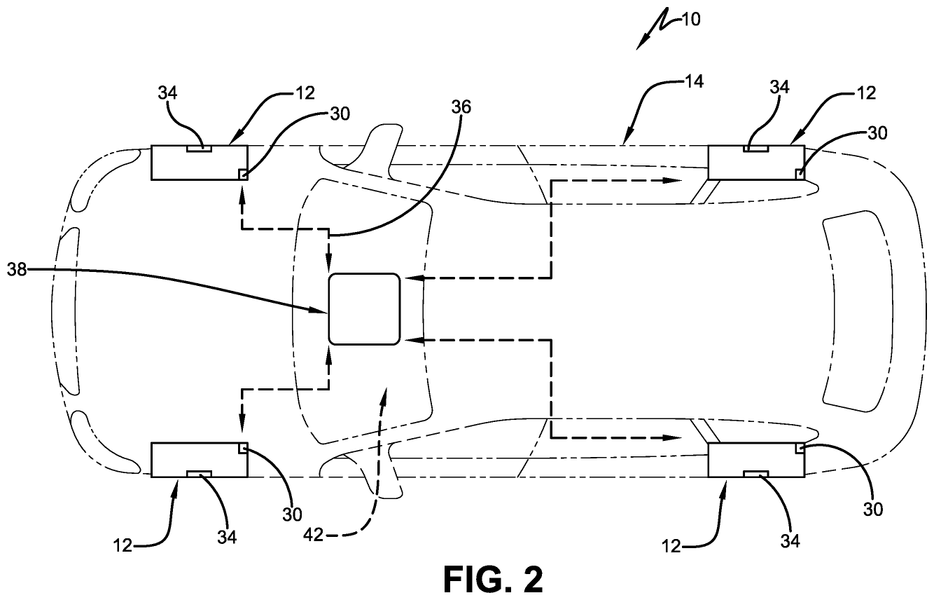

Turning now to FIG. 2, the TMPS sensor 30 and the tire ID tag 34 each include an antenna for wireless transmission 36 of the measured parameters of tire pressure 52, tire temperature 54, and tire load 56, as well as tire ID information 58, to a processor 38. The processor 38 may be integrated into the TPMS sensor 30 or the tire ID tag 34, or may be a remote processor, which may be mounted on the vehicle 14 or may be cloud-based. For the purpose of convenience, the processor 38 will be described as a remote processor mounted on the vehicle 14, with the understanding that the processor may alternatively be cloud-based or integrated into the TPMS sensor unit 30 or the tire ID tag 34.

The processor 38 preferably is in electronic communication with an electronic system of the vehicle 14, such as the vehicle CAN bus system 42, which is referred to as the CAN bus, or the vehicle EBS. For the purpose of convenience, reference shall be made to the CAN bus 42, with the understanding that such reference includes other electronic systems of the vehicle 14, such as the vehicle EBS.

Aspects of the tire replacement system 10 preferably are executed on the processor 38, which enables input of data from the TMPS sensor 30 and the tire ID tag 34, as well as input of data from sensors that are mounted on the vehicle 14 and which are in electronic communication with the CAN bus. For example, vehicle-mounted or vehicle-based sensors include sensors that indicate vehicle data such as the vehicle speed 68, vehicle load 70, vehicle distance traveled 72 from an odometer, and the like.

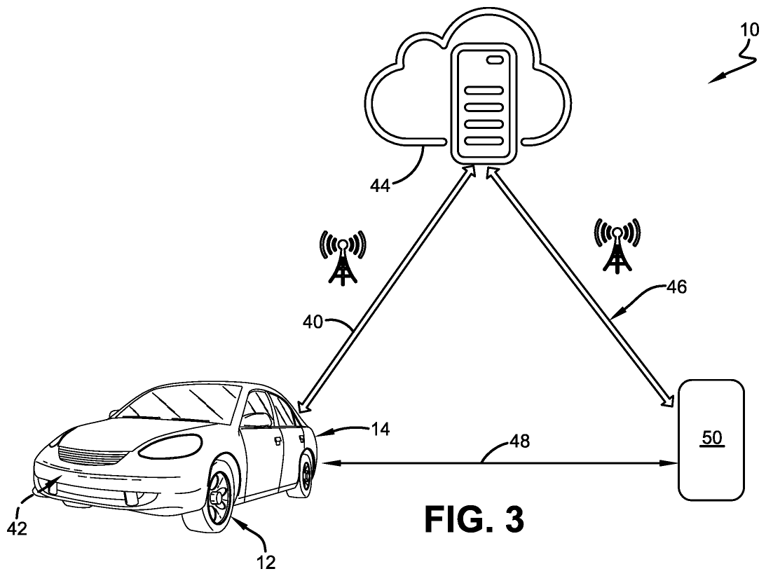

Referring to FIG. 3, when the tire data, tire ID information, and vehicle data described above are collected and correlated for each tire 12, the data may be wirelessly transmitted 40 from the processor 38 (FIG. 2) on the vehicle 14 to a processor in a cloud-based server 44. The data may be stored and/or remotely analyzed on the cloud-based server 44, and may also be wirelessly transmitted 46 to a display device 50 for a display that is accessible to a user of the vehicle 14, a technician, or a fleet manager, such as a smartphone or a computer. Alternatively, the data may be wirelessly transmitted 48 from the processor 38 on the vehicle 14 directly to the display device 50.

Turning to FIG. 4, the tire replacement system 10 includes transmission of data 74 to the processor 38. Preferably, the data 74 includes the tire ID information 58, and specifically the original tread depth 60, the rim size 62, the tire type 64, and the tire position 66 on the vehicle 14, which are transmitted from the ID tag 34 to the processor 38. Alternatively, some or all of the tire ID information 58 may be stored on a database that is in electronic communication with the processor 38. The transmitted data 74 also includes vehicle data, such as vehicle distance traveled 72 from an odometer, which is transmitted from the CAN bus 42 to the processor 38.

To increase the accuracy of the tire replacement system 10, the transmitted data 74 may include additional data that is transmitted to the processor 38. For example, the tire pressure 52, the tire temperature 54, and/or the tire load 56 may be transmitted from the TPMS sensor 30 to the processor 38. The vehicle speed 68 and/or the vehicle load 70 may be transmitted from the CAN bus 42 to the processor 38. It is to be understood that other types of information may be included in the transmitted data 74, such as traffic conditions, road conditions, weather, and the like. Each set of transmitted data 74 is time-stamped, so that the transmitted data is correlated to a specific time of measurement. In this manner, multiple sets of transmitted data 74 may be generated, with each one having a specific time stamp.

The tire replacement system 10 includes a prediction model 76, which is stored on or is in electronic communication with the processor 38. The prediction model 76 receives the transmitted data 74 and generates a remaining available distance 100 and remaining available time 102 for the tire 12 to reach a replacement tread depth 82, as will be described in greater detail below. Preferably, the prediction model 76 employs a survival analysis technique, which is a statistical technique that analyzes data inputs, such as the transmitted data 74, to estimate a duration of time remaining until an event occurs for a given component, such as each tire 12.

The survival analysis technique employed by the prediction model 76 preferably is a parametric model, which assumes a fixed mathematical form to calculate an output. Residuals, which are differences between observed and predicted values, are then adjusted by a non-parametric model. The results are generated in different forms such as plots, files, and variables in an interactive environment. The survival analysis technique and the non-parametric models take multiple continuous and categorical parameters as input.

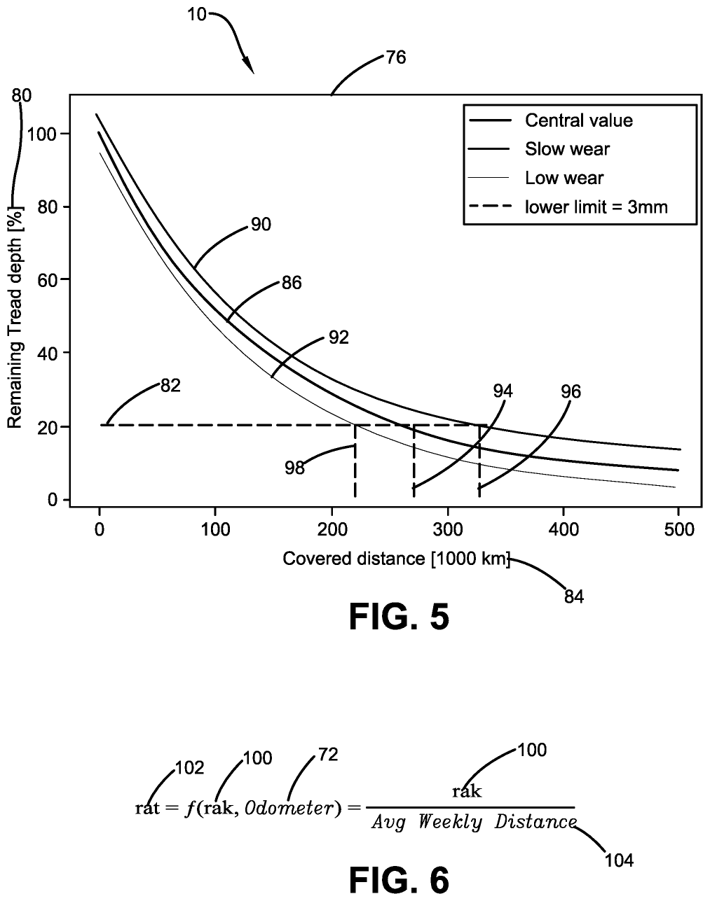

Each tire 12 includes an original tread depth 60, as shown in FIG. 1. With reference to FIGS. 4 and 5, as the tire 12 wears, the tread depth decreases and is indicated as a remaining tread depth 80. The remaining tread depth 80 may be expressed as a dimension or a percentage of the original tread depth 60. A replacement tread depth 82 is identified, which may be a specific dimension or a specific percentage of the original tread depth 60. In FIG. 5, the replacement tread depth 82 is set at 20 percent (%) of the original tread depth 60.

The survival analysis technique in the prediction model 76 generates a central decay curve 86 as a function of the remaining tread depth 80 versus a distance 84 traveled by the tire 12. The central decay curve 86 represents a typical expected wear rate for the tire 12. An upper decay curve 90 may also be generated, which represents a slower wear rate for the tire 12. A lower decay curve 92 may further be generated, which represents a faster wear rate for the tire 12.

For the typical expected wear rate 86, an expected travel distance for 84 the tire 12 to reach the replacement tread depth 82 is indicated at 94. For example, when the replacement tread depth 82 is set at 20% of the original tread depth 60, the expected distance 94 for the tire 12 to travel to reach the replacement tread depth is 270,000 kilometers (km). For the slower wear rate 90, an expected distance for the tire 12 to reach the replacement tread depth 82 is indicated at 96, which is 320,000 km. For the faster wear rate 92, an expected distance for the tire 12 to reach the replacement tread depth 82 is indicated at 98, which is 220,000 km.

Since the expected distance 94 for the tire 12 to reach the replacement tread depth 82 has been identified, a remaining available distance 100 (FIG. 6) that the tire can travel may be generated. The tire ID information 58 provides a distance traveled by the vehicle 14 when the tire 12 was new and at its original tread depth 60. A current vehicle distance traveled 72 may be obtained from the odometer. The travel distance 84 experienced by the tires 12 may be determined by subtracting the travel distance 72 of the vehicle 14 when the tire 12 was new from the current travel distance of the vehicle.

The remaining available distance 100 at the typical expected wear rate 86 is calculated by subtracting the travel distance experienced by the tire 12 from the expected distance 94 for the tire to reach the replacement tread depth 82 at the typical expected wear rate. The remaining available distance 100 at the slower wear rate 90 is calculated by subtracting the travel distance experienced by the tire 12 from the expected distance 96 for the tire to reach the replacement tread depth 82 at the slower wear rate. The remaining available distance 100 at the faster wear rate 92 is calculated by subtracting the travel distance experienced by the tire 12 from the expected distance 98 for the tire to reach the replacement tread depth 82 at the faster wear rate.

As shown in FIG. 6, the remaining available distance 100 may be converted to remaining available time 102 to reach the replacement tread depth 82. An average weekly distance 104 traveled by the vehicle 14 may be monitored through the vehicle distance traveled 72 from the odometer. The remaining available time 102 to reach the replacement tread depth 82 is determined by dividing the remaining available distance 100 by the average weekly distance 104.

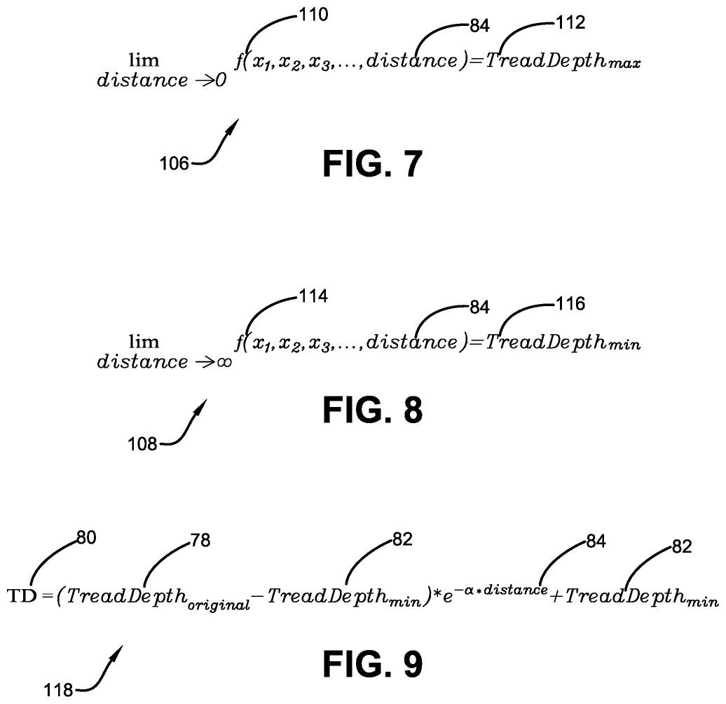

In order to provide greater accuracy for the tire replacement system 10, the precision of the decay curves 86, 90, 92 may be improved. One approach to improve such precision includes estimation of the tread depth 80 using physical parameters of the tire 12. For example, using an equation 106 shown in FIG. 7, a first function 110 expresses an estimation of the tread depth 80 as a minimum tread depth 112 depending on several parameters, x₁, x₂, x₃. Using an equation 108 shown in FIG. 8, a second function 114 expresses an estimation of the tread depth 80 as a maximum tread depth 116 depending on the parameters, x₁, x₂, x₃.

In each function 110 and 114, the parameters x₁, x₂, x₃ include selected available parameters from the transmitted data 74, such as the tire pressure 52, the tire temperature 54, and the tire load 56. The tire travel distance 84 is a consistently available parameter according to the determination above. In this manner, the precision of the decay curves 86, 90, 92 is improved, as when the travel distance 84 of the tire 12 is zero (0), the function 110 should return the maximum value 112 of the tread depth, which is the original depth 60. When the travel distance 84 of the tire 12 is an extremely large value, the function 114 should return the minimum value 116 of the tread depth, which is the replacement tread depth 82.

An equation 118 shown in FIG. 9 is preferred to improve the precision of the precision of the decay curves 86, 90, 92 through estimation of the tread depth 80, which is an exponential decay function that includes the limits of equations 106 and 108. In equation 118, TD is the remaining tread depth 80 to be predicted, preferably in millimeters, TreadDepth_{original} is the original tread depth 60 of the tire 12, TreadDepthₘᵢₙ is the replacement tread depth 82, distance is the travel distance 84 of the tire, preferably in kilometers, and alpha (α) is a shape parameter that modifies the slope of the decay curves 86, 90, 92.

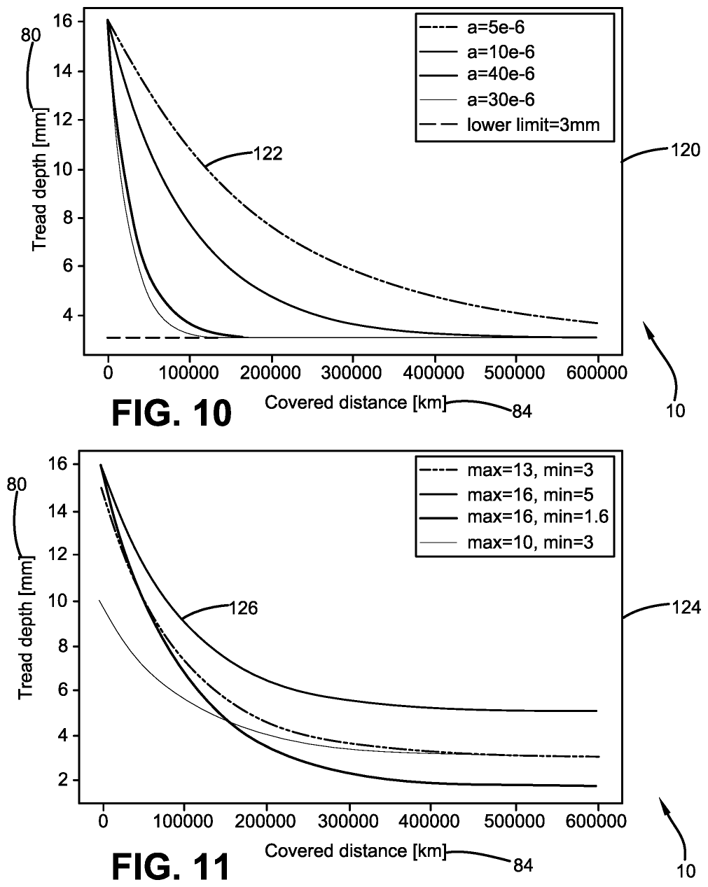

A modified prediction model 120 is shown in FIG. 10, and illustrates an adjustment to decay curves 122 from the original decay curves 86, 90, 92 according to the shape parameter alpha α. An additional modified prediction model 124 is shown in FIG. 11, and illustrates further adjustment to decay curves 126 according to the original tread depth 60 of the tire 12 and the replacement tread depth 82.

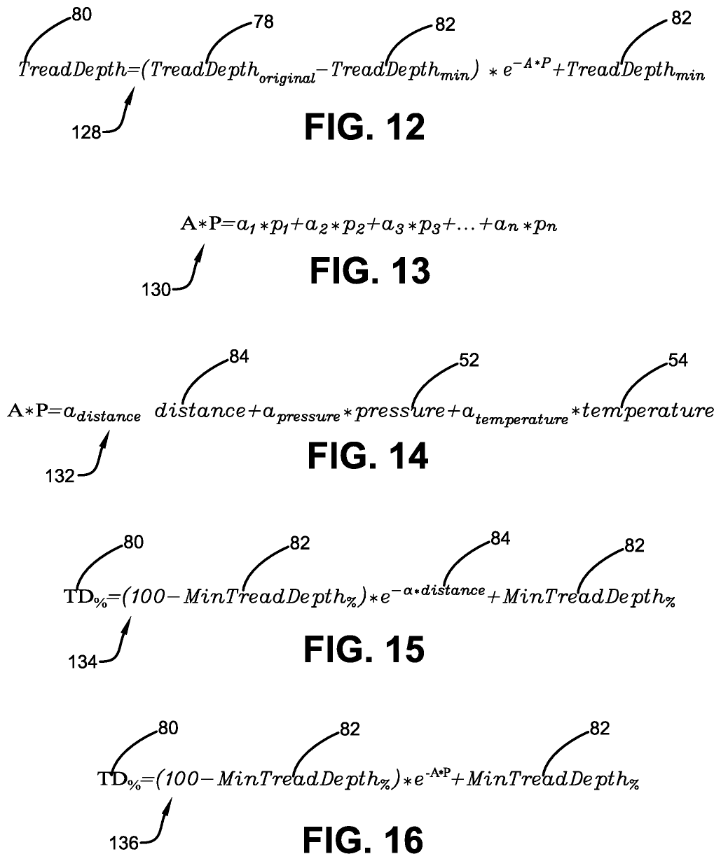

To account for as many variables or parameters as possible, the equation 118 may be modified to a final equation 128 as shown in FIG. 12. In the final equation 128, the shape parameter alpha (α) is replaced by a matrix A, and the tire travel distance 84 is replaced by a matrix P of parameters. The dot product of matrix A and matrix P may be read as a linear transformation, which is indicated at 130 in FIG. 13. An example of a linear transformation including specific parameters from the transmitted data 74 is indicated at 132 in FIG. 14. The linear transformation 132 includes the travel distance 84 of the tire 12, the tire pressure 52, and the tire temperature 54. Additional parameters from the transmitted data 74 may be added to continue to increase the precision of the decay curves 86, 90, 92 and in turn increase the accuracy of the tire replacement system 10.

Another approach to improve the precision of the decay curves 86, 90, 92 to provide greater accuracy for the tire replacement system 10 includes estimation of the tread depth 80 as a percentage. In this case, the equation 118 shown in FIG. 9 loses its geometric elements and assumes the form of equation 134 in FIG. 15. In the equation 134, TD is the remaining tread depth 80 to be predicted as a percentage, MinTreadDepth_{%} is the replacement tread depth 82 of the tire 12 expressed as a percentage, distance is the travel distance 84 of the tire, preferably in kilometers, and alpha (α) is the shape parameter that modifies the slope of the decay curves 86, 90, 92.

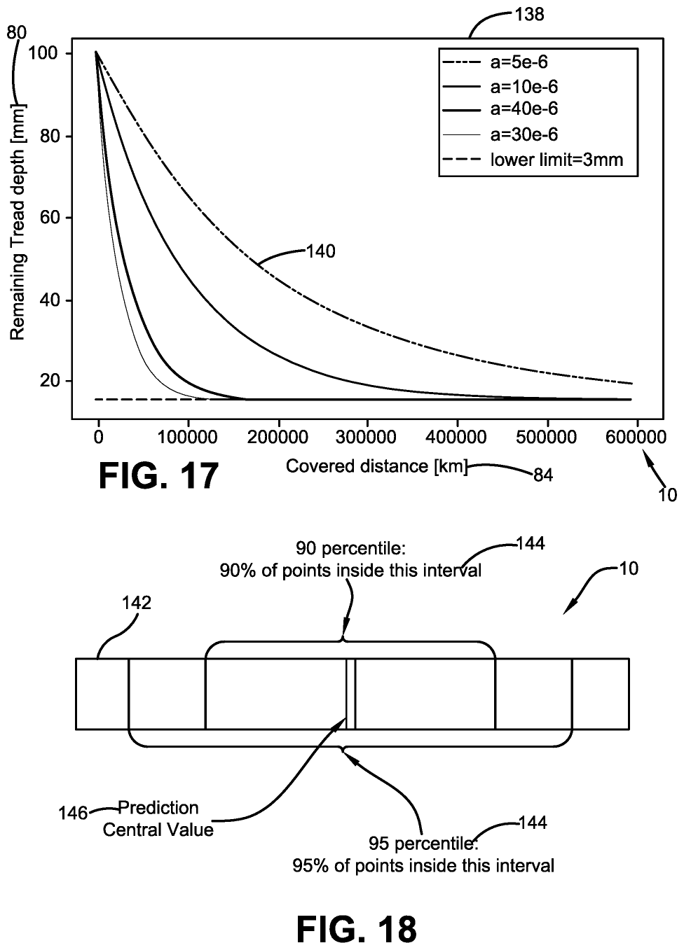

To account for as many variables or parameters as possible, the equation 134 may be modified to a final equation 136 as shown in FIG. 16. In the final equation 136, the shape parameter alpha (α) is replaced by a matrix A, and the tire travel distance 84 is replaced by the matrix P of parameters. A modified prediction model 138 is shown in FIG. 17, and illustrates an adjustment to decay curves 140 from the original decay curves 86, 90, 92 according to the shape parameter alpha a based on the replacement tread depth 82 of the tire 12 as a percentage.

As shown in FIG. 4, the tire replacement system 10 preferably includes a residual or error correction module 142 to optimize the estimation of the remaining available time 102 for the tire 12 to reach the replacement tread depth 82. More particularly, the residual correction module 142 preferably includes a machine learning model that trains an analysis model, such as a Random Forest Model or a Neural Network Model, to minimize statistical error and thus optimize the estimation of the remaining available time 102 for the tire 12 to reach the replacement tread depth 82.

The model of the residual correction module 142 preferably is trained using about 60 percent (%) of the tires 12 for which the transmitted data 74 is received, while the remaining 40% is used to estimate the remaining available time 102 to reach the replacement tread depth 82. Preferably, the division between the 60% and 40% is determined using the tire ID information 58 to ensure that tires 12 used during the model training are not used to test the model to further optimize the accuracy of the tire replacement system 10.

The metrics used in the model of the residual correction module 142 preferably include an adjusted R², which is a modified coefficient of determination for the proportion of the variation in the dependent variable that is predicted from the independent variables as adjusted for the number of predictors in the model. The metrics preferably also include mean absolute error (MAE) between paired observations. The adjusted R² and the MAE are traditional metrics in model error computation.

The metrics in the model of the residual correction module 142 preferably also include predetermined percentiles of absolute error, as shown in FIG. 18. For example, the metrics preferably include a 75-percentile of absolute error, a 90-percentile of absolute error, and a 95-percentile of absolute error. A central value of prediction 146 may not return a perfect match with a real observation, so it is preferable to identify a confidence interval 144 around the central value that will include the observed points. The confidence interval 144 is a range of estimates defined by a lower bound and upper bound and refers to the level of accuracy in the prediction. The larger the confidence interval 144, the larger the number of points that the interval includes. The objective is to include the largest part of points in the smaller interval of confidence 144.

In order to have a representative metrics, it is preferred to calculate the interval of confidence 144 that includes 75%, 90% and 95% of the error. For example, the remaining available time 102 for the tire 12 to reach the replacement tread depth 82 +/− interval [95%] indicates that 95% of the time the tire will reach its end of life in the estimated remaining available time. The confidence intervals 144 preferably are determined by calculating the absolute error of each point of the test database and generating a list, and the desired percentile on the list is generated at the previous point. The confidence interval 144 can be adjusted to any desired percentage, such as 50%, 75%, and 95%.

It is to be understood that, because the replacement tread depth 82 of the tire 12 is expressed as a percentage, the error around the central value is also expressed as a percentage of the original tread depth 60. To convert the error to a dimension, the error may be multiplied by the original tread depth 60 dimension. For example, if the 95% percentile of the error is 10%, to convert to a dimension, 10% * 16 mm equals 1.6 mm when the tire 12 was at an original tread depth 60 of 16 mm. Consequently, 95% of points will be included in a range between the central value provided by the model and 1.6 mm.

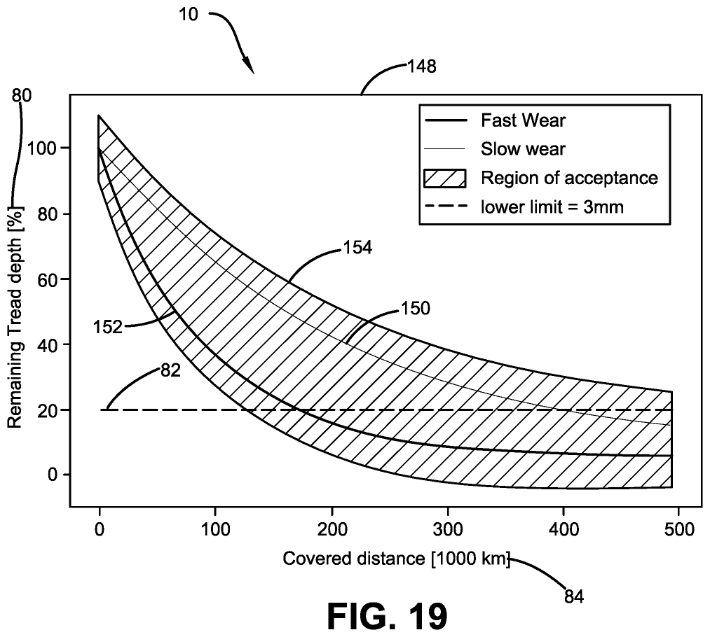

Referring to FIGS. 4 and 19, an optional filter module 148 is stored on or is in electronic communication with the processor 38. More particularly, in order to improve the accuracy of the tire replacement system 10, it is beneficial to filter certain data 74. For example, data for certain tires 12 may be filtered out, such as tires that do not have recognizable ID information 58, tires that have been retreaded as indicated by the tire ID information, and tires that have experienced significant tread wear before the tire replacement system 10 was implemented, such as more than about 0.5 millimeters (mm) of tread loss.

The filter module 148 preferably also filters out data 74 tires 12 for which insufficient data points exist, so that the tire replacement system 10 may accurately analyze trends in the data transmitted to the processor 38. Moreover, the filter module 148 preferably manages outliers in the transmitted data 74. Specifically, to manage outliers, the filter module 148 removes individually isolated points or points for which tread depth is anomalous, such as tires 12 with no wear after 100,000 km, or tires that are fully worn after 5000 km. A preferred technique employed by the filter module 148 includes using transmitted data 74 for only tires 12 with a predetermined wear rate range, such as a wear rate that is greater than 0.3 mm for each 10,000 km in tire traveled distance 84 and lower than 4 mm for each 10,000 km of tire traveled distance.

As shown in FIG. 19, in the filter module 148, a slow wear curve 150 and a fast wear curve 152 may be determined. An acceptance region 154 for data may be generated, which is obtained by shifting the slow wear curve 150 up by a predetermined amount, such as about 10%, and by shifting the fast wear curve 152 down by a predetermined amount, such as about 10%. Data in the acceptance region 154 thus is accepted and employed in the tire replacement system 10.

Returning to FIG. 4, after the transmitted data 74 is processed by the prediction model 76, the model modifications 120, 124, and/or 138 are performed, the error correction is executed in the residual correction module 142, and the data is filtered in the filter module 148, a replacement lead time determination 156 is generated by the tire replacement system 10. The replacement lead time determination 156 corresponds to the remaining available time 102 for the tire 12 to reach the replacement tread depth 82 at the time of the determination.

A notification 158 of the replacement lead time determination 156 is generated by the tire replacement system 10, which is transmitted to the CAN bus 42 or other vehicle electronic control system, the cloud-based server 44, and/or the display device 50. In this manner, the notification 158 of the replacement lead time determination 156 is communicated to a user of the vehicle 14, a technician, and/or a fleet manager. The notification 158 preferably is sent at a predetermined lead time, such as about three (3) months before the replacement tread depth 82 for a fast-wearing tire 12. The number and frequency of the notifications 158 may be adjusted as desired, such as to 12 months, 6 months, 3 months, and 1 month before tire 12 reaches the replacement tread depth 82.

In this manner, the tire replacement system 10 of the present invention accurately and reliably estimates the wear rate of a tire 12 and generates a forecast for replacement of the tire. Parameters can be added or suppressed for use in the system 10 based on their availability and on the accuracy of the estimation that is generated. The tire replacement system 10 focuses on the remaining time available for the tire 12 to be used until a replacement tread depth 82 is reached. The tire replacement system 10 finds application in tires 12, vehicles 14, and fleets of vehicles with different characteristics and uses, such as long haul trucks, regional haul trucks, mixed service trucks, buses, and passenger fleets.

The present invention also includes a method of estimating the wear rate of a tire 12 and a method of generating a forecast for replacement of the tire. Each method includes steps in accordance with the description that is presented above and shown in FIGS. 1 through 19.

It is to be understood that the structure and method of the above-described tire replacement system may be altered or rearranged, or components or steps known to those skilled in the art omitted or added, without affecting the overall concept or operation of the invention. For example, while the vehicle 14 is depicted as a passenger car for the purpose of convenience, the invention finds application in other vehicle categories such as commercial trucks and trailers, off-the-road vehicles, and the like, in which vehicles may be supported by more or fewer tires.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A replacement system for a tire supporting a vehicle, the vehicle including an electronic system, the system comprising:
a processor in electronic communication with the electronic system of the vehicle;
an electronic memory capacity for storing identification information for the tire;
the processor receiving identification information for the tire from the electronic memory capacity and vehicle data from the electronic system of the vehicle;
a prediction model in electronic communication with the processor and receiving the identification information for the tire and the vehicle data;
an identification of a replacement tread depth for the tire included in the prediction model;
an estimation of remaining available distance for the tire to reach the replacement tread depth being determined by the prediction model;
an estimation of remaining available time to reach the replacement tread depth being determined by the prediction model from the estimation of remaining available distance for the tire to reach the replacement tread depth;
a residual correction module in electronic communication with the processor to optimize the estimation of the remaining available time for the tire to reach the replacement tread depth;
a replacement lead time determination being generated by the tire replacement system and corresponding to the estimation of remaining available time for the tire to reach the replacement tread depth; and
a notification of the replacement lead time being generated by the tire replacement system and transmitted to at least one of the electronic system of the vehicle, a cloud-based server, and a display device.

2. The replacement system for a tire supporting a vehicle of claim 1, wherein the tire identification information includes an original tread depth of the tire, a rim size of the tire, a type of the tire, and a position of the tire on the vehicle.

3. The replacement system for a tire supporting a vehicle of claim 1, wherein the vehicle data includes at least one of a vehicle distance traveled, a vehicle speed, and a vehicle load.

4. The replacement system for a tire supporting a vehicle of claim 1, wherein the electronic system of the vehicle includes at least one of a controlled area network bus and an electronic braking system.

5. The replacement system for a tire supporting a vehicle of claim 1, further comprising a sensor unit being mounted to the tire and being in electronic communication with the processor, the sensor unit measuring tire parameters, the tire parameters including at least one of tire pressure, tire temperature, and tire load, wherein the prediction model receives the tire parameters.

6. The replacement system for a tire supporting a vehicle of claim 1, wherein the prediction model employs a survival analysis technique.

7. The replacement system for a tire supporting a vehicle of claim 1, wherein the prediction model generates at least one decay curve as a function of a remaining tread depth versus a distance traveled by the tire, in which the at least one decay curve represents a wear rate for the tire.

8. The replacement system for a tire supporting a vehicle of claim 7, wherein the prediction model generates a decay curve for a typical wear rate of the tire, a decay curve for a slow wear rate of the tire, and a decay curve for a fast wear rate of the tire.

9. The replacement system for a tire supporting a vehicle of claim 7, wherein an expected travel distance for the tire to reach the replacement tread depth is identified from the at least one decay curve.

10. The replacement system for a tire supporting a vehicle of claim 9, wherein the estimation of remaining available distance for the tire to reach the replacement tread depth is calculated by subtracting a travel distance experienced by the tire from the expected distance for the tire to reach the replacement tread depth.

11. The replacement system for a tire supporting a vehicle of claim 7, wherein a precision of the at least one decay curve is improved by an estimation of a remaining tread depth of the tire using physical parameters of the tire, the physical parameters of the tire including at least one of a travel distance of the tire, a tire pressure, and a tire temperature.

12. The replacement system for a tire supporting a vehicle of claim 7, wherein the prediction model includes a shape parameter to modify a slope of the at least one decay curve.

13. The replacement system for a tire supporting a vehicle of claim 12, wherein the estimation of a remaining tread depth of the tire is estimated as a dimension or as a percentage.

14. The replacement system for a tire supporting a vehicle of claim 1, wherein the estimation of remaining available distance is converted to the estimation of remaining available time to reach the replacement tread depth by dividing the estimation of remaining available distance by an average time-based distance traveled by the vehicle.

15. The replacement system for a tire supporting a vehicle of claim 1, wherein the residual correction module includes a machine learning model.

16. The replacement system for a tire supporting a vehicle of claim 15, wherein the machine learning model includes predetermined percentiles of absolute error.

17. The replacement system for a tire supporting a vehicle of claim 16, wherein the machine learning model identifies a confidence interval around a central value that includes observed points.

18. The replacement system for a tire supporting a vehicle of claim 1, further comprising a filter module in electronic communication with the processor.

19. The replacement system for a tire supporting a vehicle of claim 18, wherein the filter module allows the tire replacement system to employ data when the tire is within a predetermined wear rate range.

20. The replacement system for a tire supporting a vehicle of claim 19, wherein the filter module employs an acceptance region about a slow wear curve and a fast wear curve, wherein the slow wear curve and the fast wear curve are functions of a remaining tread depth versus a distance traveled by the tire.
